(19) United States
(12) Patent Application Publication
(10) Pub. No.: US 2020/0220239 A1
(43) Pub. Date: Jul. 9, 2020

(54) HEAT PIPE AND SECONDARY BATTERY COMPRISING HEAT PIPE

(71) Applicant: NGK Insulators, Ltd., Nagoya-Shi (JP)

(72) Inventors: Toshikatsu KASHIWAYA, lnazawa-Shi (JP); Mikio TANAKA, Seoul-City (KR); Hiroki ABE, Nagoya-Shi (JP)

(73) Assignee: NGK Insulators, Ltd., Nagoya-Shi (JP)

(21) Appl. No.: 16/823,922

(22) Filed: Mar. 19, 2020

Related U.S. Application Data
(63) Continuation of application No. PCT/JP2018/033320, filed on Sep. 7, 2018.

(30) Foreign Application Priority Data
Sep. 29, 2017 (JP) 2017-191442

(51) Int. Cl. H01M 10/6552; F28D 15/02; F28D 15/04; H01M 10/613

(52) U.S. Cl. CPC H01M 10/6552; H01M 10/613; F28D 15/043; F28D 15/0275

(57) ABSTRACT

A heat pipe disclosed herein may include a tubular body sealing a working fluid therein; and a wick disposed on at least a part of inside of the tubular body. The tubular body may include a ceramic portion constituted of a ceramic material. An axial length of the ceramic portion may be equal to or greater than L/2, where L is an axial length of the tubular body.

### TECHNICAL FIELD

The technique disclosed herein relates to a heat pipe. Specifically, the technique disclosed herein relates to a heat pipe used suitably for cooling a secondary battery.

### BACKGROUND ART

It is known that secondary batteries, such as lithium-ion secondary batteries, generate heat when discharging and being recharged, as a result of which they come to have a high temperature. Since subjecting secondary batteries to a high temperature for a long time may cause deterioration of the performance of the secondary batteries, techniques for cooling secondary batteries have been developed. For example, a secondary battery described in Japanese Patent Application Publication No. 2011-113895 includes a wound-type electrode body and a center pin disposed at the center of the electrode body. The center pin is constituted of a metal having high thermal conductivity and axially extends along an axis of the electrode body. In this secondary battery, when the electrode body generates heat due to discharging and recharging, the heat is transferred outward from the central part of the electrode body through the center pin, as a result of which the secondary battery is cooled.

### SUMMARY OF INVENTION

### Technical Problem

In the secondary battery of Japanese Patent Application Publication No. 2011-113895, the center pin in the electrode body is constituted of a metal having high thermal conductivity, thus heat generated inside the electrode body can be efficiently transferred to the outside. On the other hand, since the metal center pin is disposed to penetrate the center of the electrode body, a short circuit is highly likely to occur via the center pin between a positive electrode plate and a negative electrode plate of the electrode body. The disclosure herein provides a technique that can prevent a short circuit in a secondary battery and can efficiently cool the secondary battery.

### Solution to Technical Problem

A heat pipe disclosed herein may comprise a tubular body sealing a working fluid therein; and a wick disposed on at least a part of an inside of the tubular body. The tubular body may include a ceramic portion constituted of a ceramic material. An axial length of the ceramic portion of the tubular body may be equal to or greater than L/2, where L is an axial length of the tubular body.

In the above-described heat pipe, the working fluid circulates in the tubular body, and heat is thereby transferred efficiently. Further, since the tubular body includes the ceramic portion constituted of the ceramic material and the axial length of the ceramic portion is equal to or greater than L/2, the above-described heat pipe, when disposed in a secondary battery, can efficiently cool the secondary battery and can prevent a short circuit in the secondary battery.

A secondary battery disclosed herein may comprise a battery casing; an electrode body accommodated within the battery casing; and a heat pipe accommodated within the battery casing and cooling the electrode body. This heat pipe may be any of heat pipes disclosed herein. This secondary battery can efficiently cool the electrode body and can prevent a short circuit in the secondary battery.

### BRIEF DESCRIPTION OF DRAWINGS

FIG. 1 is a cross-sectional view showing a configuration of a heat pipe 10 according to a first embodiment;

FIG. 2 is a cross-sectional view showing a configuration of a heat pipe 30 according to a second embodiment;

FIG. 3 is a cross-sectional view showing a configuration of a heat pipe 40 according to a third embodiment;

FIG. 4 is a cross-sectional view showing a configuration of a heat pipe 50 according to a fourth embodiment;

FIG. 5 is a vertical cross-sectional view showing a configuration of a lithium-ion secondary battery comprising the heat pipe 10 according to the first embodiment;

FIG. 6 is a cross-sectional view along a line VI-VI in FIG. 5; and

FIG. 7 is a schematic diagram showing another configuration of a lithium-ion secondary battery comprising a heat pipe according to any of the embodiments disclosed herein.

### DESCRIPTION OF EMBODIMENTS

In the heat pipe disclosed herein, an entirety of the tubular body may be constituted of the ceramic material. Using such a heat pipe to cool a secondary battery can suitably prevent a short circuit in the secondary battery.

In the above-described heat pipe, the tubular body may comprise a tubular main portion; a first cover portion disposed at one end of the main portion and sealing the one end; and a second cover portion disposed at other end of the main body and sealing the other end. The wick may not be disposed on an inner surface of at least one of the first cover portion and the second cover portion. Since the wick is not disposed on the at least one of the cover portions in the above configuration, connecting the main portion with the at least one of the cover portions can be facilitated and the ends of the main portion can be suitably sealed.

In the heat pipe disclosed herein, the tubular body may comprise a first portion constituted of the ceramic material; and a second portion constituted of a metal material that has higher thermal conductivity than the ceramic material. Further, a relationship of L1>L2 may be satisfied, where L1 is an axial length of the first portion and L2 is an axial length of the second portion. Such a configuration can improve the cooling performance of the heat pipe because the tubular body comprises the second portion constituted of the metal material having high thermal conductivity. Even with the presence of the metal second portion, using this heat pipe to cool a secondary battery can also prevent a short circuit in the secondary battery because the axial length L2 of the second portion is shorter than the axial length L1 of the ceramic first portion.

In the above-described heat pipe, the first portion may be disposed at one end of the tubular body. Further, the second portion may be disposed at other end of the tubular body and may be joined to other end of the first portion. The wick may be disposed on at least a part of the first portion.

Further, in the above-described heat pipe, the first portion may be disposed at a central part of the tubular body. Further, the second portion may comprise a first cover portion disposed at one end of the tubular body and joined to one end of the first portion; and a second cover portion disposed at other end of the tubular body and joined to other end of the first portion. The wick may be disposed on at least a part of the first portion.

Alternatively, in the above-described heat pipe, the second portion may be disposed at a central part of the tubular body. Further, the first portion may comprise a first cover portion disposed at one end of the tubular body and joined to one end of the second portion; and a second cover portion disposed at other end of the tubular body and joined to other end of the second portion. The wick may be disposed on at least a part of the first portion.

A secondary battery comprising any of the above-described heat pipes may comprise a battery casing; and an electrode body accommodated within the battery casing. When the electrode body and the heat pipe are viewed along an axial direction of the heat pipe, the electrode body may be disposed around the heat pipe. Such a configuration can suitably transfer heat generated inside the electrode body to outside the electrode body.

In the above-described secondary battery, the battery casing may comprise a terminal surface on which an external terminal is disposed. The external terminal may be connected to the electrode body. Further, one end of the heat pipe may extend toward the terminal surface. Such a configuration can easily dissipate heat transferred by the heat pipe from the terminal surface of the battery casing to the outside of the battery.

### First Embodiment

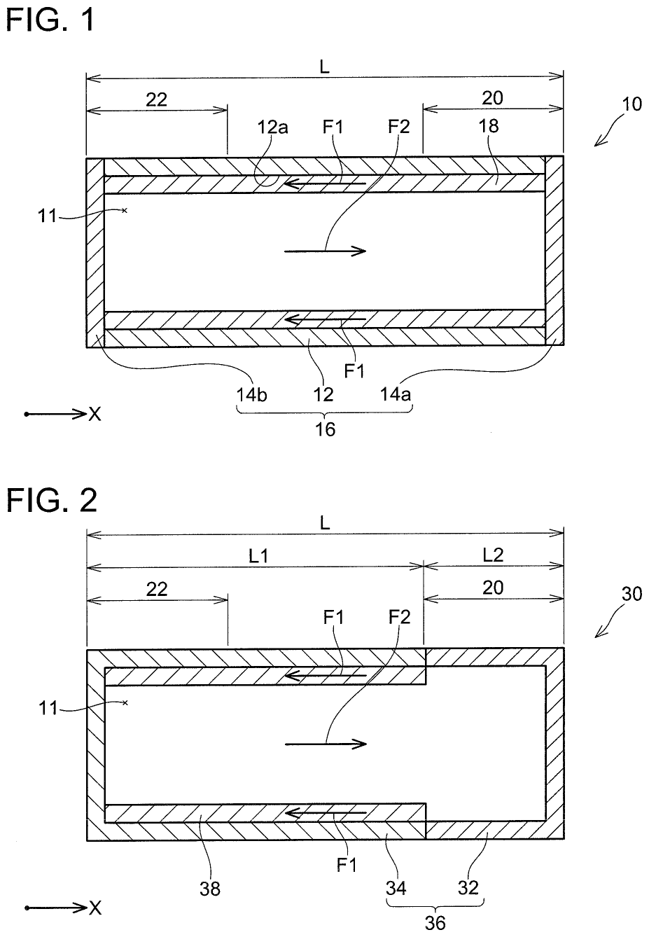

With reference to FIG. 1, a heat pipe 10 of a first embodiment will be described. The heat pipe 10 includes a tubular container 16 (an example of tubular body) and a wick 18 disposed inside the container 16.

An entirety of the container 16 is constituted of an insulative ceramic material. Examples of the ceramic material of the container 16 include oxide ceramics, such as alumina and zirconia, and nitride ceramics having high thermal conductivity (such as AlN, Si₃N₄, SiC). Composite materials of glass materials and ceramics can be also used as the ceramic material of the container 16. The container 16 may be partially constituted of a glass material.

The container 16 includes a tubular main portion 12 of which both ends are open, a first cover portion 14a closing one end of the main portion 12, and a second cover portion 14b closing the other end of the main portion 12. The main portion 12, the first cover portion 14a, and the second cover portion 14b are constituted of the same ceramic material. The first cover portion 14a is joined to the main portion 12 by a publicly known method. A glass material seals between the first cover portion 14a and the main portion 12. Further, the second cover portion 14b is also joined to the main portion 12 by a publicly known method, and a glass material seals therebetween.

The container 16 seals a fluid (working fluid) therein. Examples of the fluid sealed within the container 16 include water, ammonia, and organic solvents. Examples of the organic solvents include acetone, alcohol, chlorofluorocarbon, glycol ethers, naphthalene, diethyldiphenyl, and the like. From among the above, one that changes from a liquid phase to a gas phase in a temperature range where the heat pipe 10 is used is appropriately selected as the fluid. A pressure in the container 16 is adjusted (reduced) such that the fluid changes from the liquid phase to the gas phase in the temperature range where the heat pipe 10 is used. In a case where the heat pipe 10 is used in a device that uses a high voltage or a large current, it is preferable to use a fluid having high insulation properties (e.g., fluorine-based liquid).

The wick 18 has a tubular shape of which both ends are open, and is disposed inside the container 16. The wick 18 is arranged on an inner surface of the main portion 12, while no wick is arranged on inner surfaces of the cover portions 14a and 14b. However, a wick may be arranged on the inner surfaces of the cover portions 14a and 14b. One end of the wick 18 is in contact with the first cover portion 14a, and other end of the wick 18 is in contact with the second cover portion 14b. Since the wick 18 has the tubular shape, a space 11 is formed within the wick 18. The space 11 axially extends inside the container 16 from the first cover portion 14a to the second cover portion 14b. The wick 18 includes pores that cause capillary action of the fluid. The wick 18 is constituted of the same ceramic material as the container 16. The main portion 12 and the wick 18 may be integrated by joining the wick 18 to the main portion 12. Alternatively, the main portion 12 and the wick 18 may be manufactured separately, and then the wick 18 may be inserted into the main portion 12. In the present embodiment, the wick 18 is constituted of the ceramic material, however, it may be constituted of a material other than the ceramic material, such as resin and metal.

A method of using the above-described heat pipe 10 will be described. The one end of the heat pipe 10 is placed at a high-temperature part (heat-input part) 22, and the other end thereof is placed at a low-temperature part (heat dissipating part) 20. The fluid in the heat pipe 10 changes from the liquid phase to the gas phase at the high-temperature part 22. The fluid in the gas phase moves to the low-temperature part 20 through the space 11 in the wick 18 (arrow F2 in the drawing). When having moved to the low-temperature part 20, the fluid changes from the gas phase to the liquid phase at the low-temperature part 20. The fluid in the liquid phase moves to the high-temperature part 22 by the capillary action of the wick 18 (arrows F1 in the drawing). When the fluid in the liquid phase has moved to the high-temperature part 22, it changes to the gas phase at the high-temperature part 22 and moves to the low-temperature part 20 through the space 11. The fluid circulates in the heat pipe 10 according to the above cycle. Heat can be efficiently transferred from the high-temperature part 22 to the low-temperature part 20 by the fluid circulating in the heat pipe 10 while changing between the liquid phase and the gas phase.

In the heat pipe 10 of the present embodiment, the entirety of the container 16 is constituted of the ceramic material. That is, if an axial length (length in an X direction) of the container 16 is termed L, an axial length of a ceramic portion constituted of the ceramic material is also L (>L/2). Therefore, even when the heat pipe 10 is used in an environment where a short circuit could occur in an electric circuitry, it can suitably prevent a short circuit in the electric circuitry.

### Second Embodiment

With reference to FIG. 2, a heat pipe 30 of a second embodiment will be described. Differences from the first embodiment will be mainly described hereinbelow, while description for common configurations with the first embodiment will be omitted.

The heat pipe 30 includes a container 36 sealing a fluid therein and a wick 38 disposed inside the container 36. The container 36 includes a first portion 34 constituted of a ceramic material and a second portion 32 constituted of a metal material.

The first portion 34 has a tubular shape of which one end is closed but other end is open, and is disposed on a one-end side of the container 36. The ceramic material of the first portion 34 may be the same as the material described in the first embodiment. Further, the wick 38 is disposed on an inner surface of the first portion 34. As in the first embodiment, no wick is disposed on an inner surface of a cover portion that closes the one end of the first portion 34.

The second portion 32 has a tubular shape of which one end is open but other end is closed, and is disposed on an other-end side of the container 36. The second portion 32 is joined to the other end of the first portion 34 to close the other end of the first portion 34. A space between the second portion 32 and the first portion 34 is sealed. The metal material of the second portion 32 has higher thermal conductivity than the ceramic material of the first portion 34, and examples thereof include copper (Cu), aluminum (Al), an alloy of those, SUS (stainless steel), and the like. In the present embodiment, no wick is disposed on an inner surface of the second portion 32, however, a wick may be disposed on the second portion.

An axial length L1 of the first portion 34 is longer than an axial length L2 of the second portion 32. That is, the axial length L1 of the first portion constituted of the ceramic material is longer than the axial length L2 of the second portion 32 constituted of the metal material.

In the heat pipe 30 as described above as well, one end thereof is placed at the high-temperature part (heat-input part) 22, and the other end thereof is placed at the low-temperature part (heat dissipating part) 20. The fluid in the heat pipe 30 changes from the liquid phase to the gas phase at the high-temperature part 22 (i.e., at the ceramic first portion 34). The fluid in the gas phase moves to the low-temperature part 20 through the space 11 in the wick 38 (arrow F2 in the drawing). When having moved to the low-temperature part 20, the fluid changes from the gas phase to the liquid phase at the low-temperature part 20 (i.e., at the metal second portion 32). The fluid in the liquid phase moves to the high-temperature part 22 by the capillary action of the wick 38 (arrows F1 in the drawing). When the fluid in liquid phase has moved to the high-temperature part 22, it changes to the gas phase at the high-temperature part 22 and moves to the low-temperature part 20 through the space 11. The fluid circulates in the heat pipe 30 according to the above cycle, and heat is thereby efficiently transferred from the high-temperature part 22 to the low-temperature part 20.

For the heat pipe 30 of the present embodiment, the container 36 is manufactured by joining the metal second portion 32 to the ceramic first portion 34. Therefore, the container 36 can be manufactured easily. Specifically, in manufacturing of the container 36, the first portion 34 and the second portion 32 are joined together, and then the fluid is supplied into the container 36 from an opening disposed in the second portion 32 and a pressure in the container 36 is adjusted. Only thing to do after the pressure adjustment is to close the opening in the metal second portion 32. Since such a manufacturing method can be employed, the container 36 can be manufactured easily.

Further, placing the metal second portion 32 with high thermal conductivity at the low-temperature part 20 enhances the heat dissipation performance of the heat pipe 30, thus enhances the cooling performance of the heat pipe 30. Although the container 36 includes the metal second portion 32, the axial length L2 of the second portion 32 is shorter than that of the first portion 34. Therefore, even when the heat pipe 30 is used in an environment where a short circuit could occur in an electric circuitry, it can suitably prevent a short circuit in the electric circuitry.

### Third Embodiment

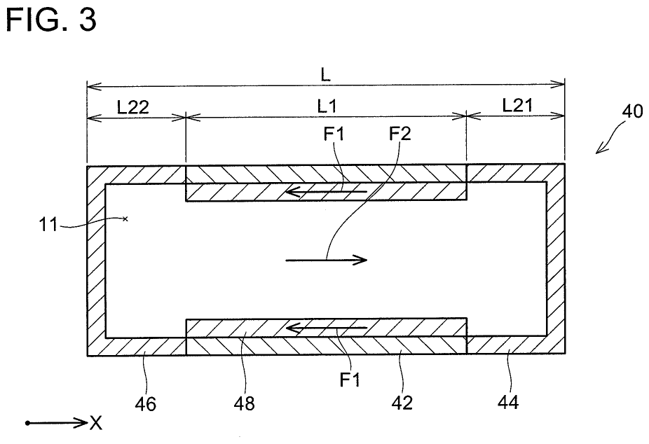

With reference to FIG. 3, a heat pipe 40 of a third embodiment will be described. The heat pipe 40 includes a container (42, 44, 46) sealing a fluid therein and a wick 48 disposed inside the container (42, 44, 46). The container (42, 44, 46) includes a first portion 42 constituted of a ceramic material, and a first cover portion 46 and a second cover portion 44 each constituted of a metal material.

The first portion 42 has a shape of which both ends are open, and is disposed at a central part of the container. The first cover portion 46 is joined to one end of the first portion 42, and the second cover portion 44 is joined to other end of the first portion 42. The both ends of the first portion 42 are closed by the cover portions 44, 46. A space between the first portion 42 and the first cover portion 46 is sealed, and a space between the first portion 42 and the second cover portion 44 is also sealed. That is, the container (42, 44, 46) is thereby sealed. The container (42, 44, 46) seals the fluid therein. Further, the wick 48 is disposed only on the first portion 42 of the container.

An axial length L1 of the first portion 42 is longer than a sum of an axial length L22 of the first cover portion 46 and an axial length L21 of the second cover portion 44 (L1 >L21+L22). That is, the axial length L1 of the portion 42 constituted of the ceramic material is longer than the axial length of the portions 44, 46 (L21+L22) constituted of the metal material. Due to this, limiting positions of the portions 44, 46 constituted of the metal material to respective end portions can suitably prevent a short circuit in an electric circuitry.

In the heat pipe 40 of the present embodiment, the metal portions 44 and 46 are placed at the high-temperature part (heat-input part) and the low-temperature part (heat dissipating part), respectively. This can enhance the heat-input performance into the heat pipe 40 and the heat-dissipation performance from the heat pipe 40, thus can enhance the cooling performance of the heat pipe 40.

### Fourth Embodiment

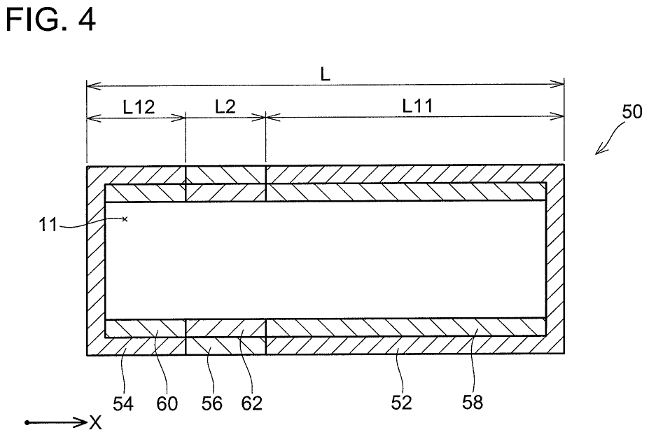

In the above-described heat pipe 40 of the third embodiment, the metal cover portions 44, 46 are disposed at both ends container, however, other configurations may be employed. In a heat pipe 50 of a fourth embodiment shown in FIG. 4, a container (52, 54, 56) includes cover portions 54 and 52 constituted of a ceramic material at the both ends of the container, and a portion 56 constituted of a metal material at a central part of the container. In this case as well, a sum of axial lengths of the ceramic cover portions 54 and 52 (L12+L11) is longer than an axial length L2 of the metal portion 56. Adjusting the position of the metal portion 56 can efficiently prevent a short circuit in an electric circuitry. In the heat pipe 50, wicks 58, 60, 62 are disposed on all the inner surfaces of the metal portion 56 and the cover portions 54, 52.

(Lithium-Ion Secondary Battery)

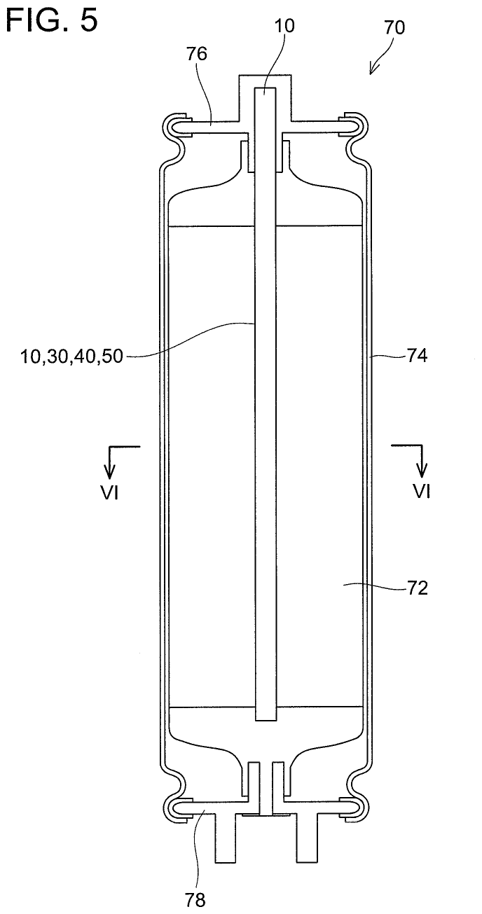

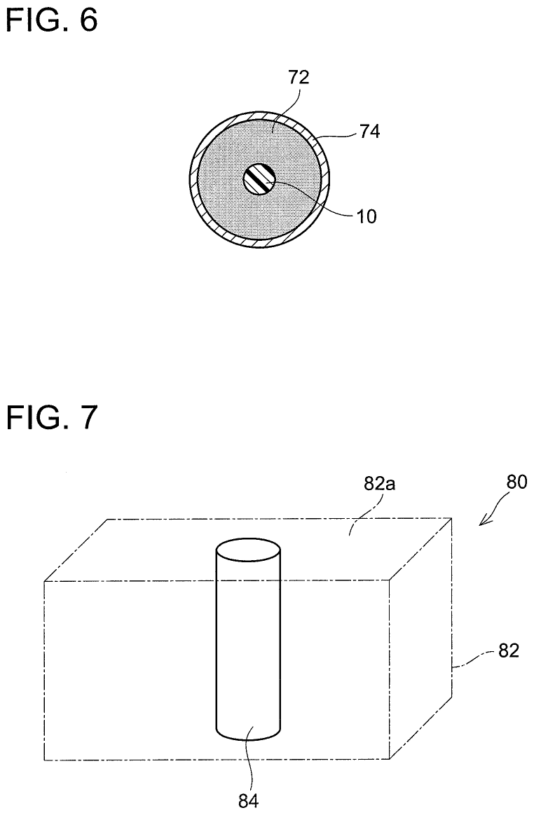

With reference to FIGS. 5 and 6, an example where the above-described heat pipe 10 is mounted in a lithium-ion secondary battery will be described. Although the heat pipe 10 is mounted in a lithium-ion secondary battery in the example described below, the other heat pipes 30, 40, and 50 can also be mounted in the lithium-ion secondary battery similarly.

As shown in FIG. 5, a lithium-ion secondary battery 70 includes a battery casing 74, an electrode body 72 accommodated within the battery casing 74, and the heat pipe 10 disposed at the center of the electrode body 72. The battery casing 74 has a cylindrical shape of which both ends are closed by terminal walls 76, 78. Each of the terminal walls 76 and 78 has an external terminal (not shown) disposed thereon.

The electrode body 72 includes a stack in which a positive electrode plate, a negative electrode plate, and a separator are stacked, and this stack is wound around an axis. The positive electrode plate of the electrode body 72 is electrically connected to the external terminal of the terminal wall 76. The negative electrode plate of the electrode body 72 is electrically connected to the external terminal of the terminal wall 78.

The heat pipe 10 is disposed on the axis of the electrode body 72 and penetrates the center of the electrode body 72. Thus, when the electrode body 72 and the heat pipe 10 are viewed along an axial direction, the electrode body 72 is disposed around the heat pipe 10 as shown in FIG. 6. One end of the heat pipe 10 is supported by the terminal wall 76, and other end of the heat pipe 10 is spaced from the terminal wall 78.

As is apparent from the above, in the lithium-ion secondary battery 70, an end portion of the heat pipe 10 that is located on a terminal wall 76 side corresponds to the low-temperature part (heat dissipating part), and a portion of the heat pipe 10 that is in contact with the electrode body 72 corresponds to the high-temperature part (heat-input part). Heat generated by the electrode body 72 due to discharging and recharging is transferred toward the terminal wall 76 via the heat pipe 10 and is dissipated from the terminal wall 76 to the outside. Since the heat pipe 10 can dissipate the heat generated at the center of the electrode body 72 to the outside, the lithium-ion secondary battery 70 can be suitably suppressed from having a high temperature. Thus, deterioration in the performance of the lithium-ion secondary battery 70 can be suitably suppressed.

Further, since the container 16 of the heat pipe 10 is constituted of the ceramic material, a short circuit can be prevented in the lithium-ion secondary battery 70, and corrosion resistance and heat resistance of the lithium-ion secondary battery 70 can be enhanced. Moreover, since a temperature rise in the lithium-ion secondary battery 70 can be suppressed, the battery capacity can be increased.

Although the secondary battery of the above-described embodiment includes the electrode body wound in a cylindrical shape, the heat pipes disclosed herein can be mounted in various types of secondary batteries. For example, they may each be mounted in a secondary battery 80 formed by shaping a wound electrode body into a flat shape, as shown in FIG. 7. A battery casing 82 has a rectangular parallelepiped shape and a rectangular cross section, and external terminals (positive and negative terminals, not shown) are disposed on an upper surface 82a of the battery casing 82. In this case as well, a heat pipe 84 has its one end supported by the upper surface 82a of the battery casing 82 and is disposed at the center of the electrode body (not shown). The heat pipes disclosed herein may each be mounted in a stacked secondary battery in which electrode bodies are stacked.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations recited in the claims as originally filed. Further, the purpose of the examples illustrated by the present description or drawings is to satisfy multiple objectives simultaneously, and satisfying any one of those objectives gives technical utility to the present disclosure.

1. A heat pipe comprising:
a tubular body sealing a working fluid therein; and
a wick disposed on at least a part of inside of the tubular body;
wherein
the tubular body includes a ceramic portion constituted of a ceramic material, and
an axial length of the ceramic portion of the tubular body is equal to or greater than L/2, where L is an axial length of the tubular body.

2. The heat pipe as in claim 1, wherein an entirety of the tubular body is constituted of the ceramic material.

3. The heat pipe as in claim 2, wherein
the tubular body comprises:
a tubular main portion;
a first cover portion disposed at one end of the main portion and sealing the one end; and
a second cover portion disposed at other end of the main body and sealing the other end,
wherein the wick is not disposed on an inner surface of at least one of the first cover portion and the second cover portion.

4. The heat pipe as in claim 1, wherein
the tubular body comprises:
a first portion constituted of the ceramic material; and
a second portion constituted of a metal material that has higher thermal conductivity than the ceramic material,
wherein a relationship of L1>L2 is satisfied, where L1 is an axial length of the first portion and L2 is an axial length of the second portion.

5. The heat pipe as in claim 4, wherein
the first portion is disposed at one end of the tubular body,
the second portion is disposed at other end of the tubular body and is joined to other end of the first portion, and
the wick is disposed on at least a part of the first portion.

6. The heat pipe as in claim 4, wherein
the first portion is disposed at a central part of the tubular body,
the second portion comprises:
a first cover portion disposed at one end of the tubular body and joined to one end of the first portion; and
a second cover portion disposed at other end of the tubular body and joined to other end of the first portion, and
the wick is disposed on at least a part of the first portion.

7. The heat pipe as in claim 4, wherein
the second portion is disposed at a central part of the tubular body,
the first portion comprises:
a first cover portion disposed at one end of the tubular body and joined to one end of the second portion; and
a second cover portion disposed at other end of the tubular body and joined to other end of the second portion, and
the wick is disposed on at least a part of the first portion.

8. A secondary battery comprising:
a battery casing;
an electrode body accommodated within the battery casing; and
the heat pipe according to claim 1, wherein the heat pipe is accommodated within the battery casing and cools the electrode body.

9. The secondary battery as in claim 8, wherein
when the electrode body and the heat pipe are viewed along an axial direction of the heat pipe, the electrode body is disposed around the heat pipe.

10. The secondary battery as in claim 8, wherein
the battery casing comprises a terminal surface on which an external terminal is disposed,
the external terminal is connected to the electrode body, and
one end of the heat pipe extends toward the terminal surface.

11. The secondary battery as in claim 9, wherein
the battery casing comprises a terminal surface on which an external terminal is disposed,
the external terminal is connected to the electrode body, and
one end of the heat pipe extends toward the terminal surface.
